(19) United States
(12) Patent Application Publication
(10) Pub. No.: US 2017/0321839 A1
(43) Pub. Date: Nov. 9, 2017

(54) FLUID CONNECTOR WITH SACRIFICIAL ANODE

(71) Applicant: GM GLOBAL TECHNOLOGY OPERATIONS LLC, Detroit, MI (US)

(72) Inventors: George E. Doerr, Clarkston, MI (US); Miroslaw Zaloga, Shelby Township, MI (US)

(73) Assignee: GM GLOBAL TECHNOLOGY OPERATIONS LLC, Detroit, MI (US)

(21) Appl. No.: 15/147,396

(22) Filed: May 5, 2016

(51) Int. Cl. F16L 58/18; B60R 16/08; B60R 19/54; B62D 3/14

(52) U.S. Cl. CPC F16L 58/18; B62D 3/14; B60R 16/08; B60R 19/54

(57) ABSTRACT

A fluid connector for connecting fluid conduit to a component in the presence of an electrolyte solution includes a connector body and sacrificial anode. The connector body defines an internal recess. The sacrificial anode can be press-fitted into the internal recess and circumscribed by the connector body. The sacrificial anode, which is constructed of a material that is configured to be consumed over a life of the component to prevent or delay corrosion of the connector body due to contact with the electrolyte solution, may be constructed of aluminum, magnesium, zinc, or other active metals. A fluid system for use in the presence of the electrolyte solution includes the component, fluid conduit, a pump, and the fluid connector. A vehicle includes the fluid system and a vehicle body. The component may be a steering gear assembly in some embodiments.

### TECHNICAL FIELD

The present disclosure pertains to the prevention or delay of corrosion of a fluid connector using a sacrificial anode.

### BACKGROUND

Fluids may be used for a variety of purposes in a system, including motion control, cooling, and lubrication. For instance, hydraulic fluid may be drawn from a fluid reservoir by a pump and circulated within the system within a loop of fluid conduit. The fluid, which may be circulated under pressure, can be used to actuate components of the system, e.g., to move a reciprocating piston or other linear or rotary actuator. Other fluids such as compressed air may be used for similar purposes.

Lengths of fluid conduit in the form of pipes, hoses, or tubing are used to interconnect the pump, fluid reservoir, valves, actuators, and any other required components, with the fluid conduit mated to the individual components using fluid connectors of various types. Such fluid connectors may be used in a wide range of possible applications and operating environments. Because of this, corrosion of the fluid connectors and the resultant compromise in sealing integrity may be an important system design concern, particularly in applications in which the fluid connector is exposed to salt water or another potentially corrosive electrolyte solution.

### SUMMARY

An improved fluid connector is disclosed herein for connecting a length of fluid conduit to a component in a fluid system. The fluid connector includes a connector body and a sacrificial anode, i.e., a positively charged active element, with the sacrificial anode being circumscribed by the connector body. The sacrificial anode is “sacrificial” in the sense that it is configured to transfer electrons over time to thereby help prevent or delay corrosion of the connector body at the expense of the sacrificial anode, a process which occurs when the connector body is in the presence of an electrolyte solution.

The connector body disclosed herein may be optionally embodied as a hydraulic fluid tube nut of the type known in the art, or as any other connector body or fastener defining an internal recess. The sacrificial anode has an external shape matching that of the internal recess, e.g., a cylindrical shape, and is constructed of active metal or other suitable material such as aluminum, magnesium, or zinc. The sacrificial anode is press-fitted into the internal recess of the connector body to form an integral unit prior to installation into a component.

When the fluid connector is installed into the component and in use, an orientation of an upper surface of the connector body causes the sacrificial anode at times to be wetted by the electrolyte solution. That is, due to the vertical or near-vertical orientation of the fluid conduit in typical installed position of the fluid connector, the electrolyte solution may accumulate at or along a conduit-to-connector body interface. In such applications, corrosion of the sacrificial anode may continue until the electrolyte fluid has fully evaporated. Thus, in the present disclosure the sacrificial anode is slowly consumed during the life of the component in lieu of the connector body so as to ensure cathodic protection of the connector body in a corrosive operating environment.

The component to which the connector body is ultimately attached may be embodied as a steering gear assembly in a non-limiting example configuration. A typically encountered electrolyte solution is salt water, particularly for vehicle operations. By way of illustration, a work vehicle such as a snow plow/salt truck may be exposed to salt water along an underbody or engine compartment of the vehicle, which over time may corrode the connector body. Other applications may similarly benefit, including marine vehicle applications in which the fluid connector remains submerged in salt water for extended periods of time, or vehicles, appliances, and other machines operated in proximity to a body of salt water in which salt water-induced corrosion is prevalent.

A fluid system is also disclosed herein for use in the presence of an electrolyte solution. The fluid system includes the component, the fluid conduit, a pump in fluid communication with the component via the fluid conduit, and the fluid connector having the sacrificial anode as noted above.

A vehicle is also disclosed for use in the presence of an electrolyte material, e.g., salt water. The vehicle includes a vehicle body and a fluid system, with the fluid system being connected to the vehicle body and configured as set forth above.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

The present disclosure is susceptible to various modifications and alternative forms, and some representative embodiments have been shown by way of example in the drawings and will be described in detail herein. It should be understood, however, that the inventive aspects of this disclosure are not limited to the particular forms disclosed. Rather, the disclosure is to cover all modifications, equivalents, combinations, sub-combinations, and alternatives falling within the scope of the disclosure as defined by the appended claims.

FIG. 1 is a schematic illustration of an example vehicle having a system with a component connected using a corrosion-resistant fluid connector constructed as set forth herein.

FIG. 1A is a schematic illustration of a fluid system 20 usable as part of the vehicle of FIG. 1 or within another application in which use of the corrosion-resistant fluid connector would be desirable.

FIG. 2 is a schematic perspective side view illustration of an example component in the form of a steering gear assembly usable with the fluid connector of the present disclosure.

FIG. 3 is a schematic cross-sectional side view illustration of a length of fluid conduit connected to a component via the improved fluid connector of the present disclosure.

FIG. 4 is a schematic perspective view illustration of a sacrificial anode usable as part of the fluid connector described herein.

### DETAILED DESCRIPTION

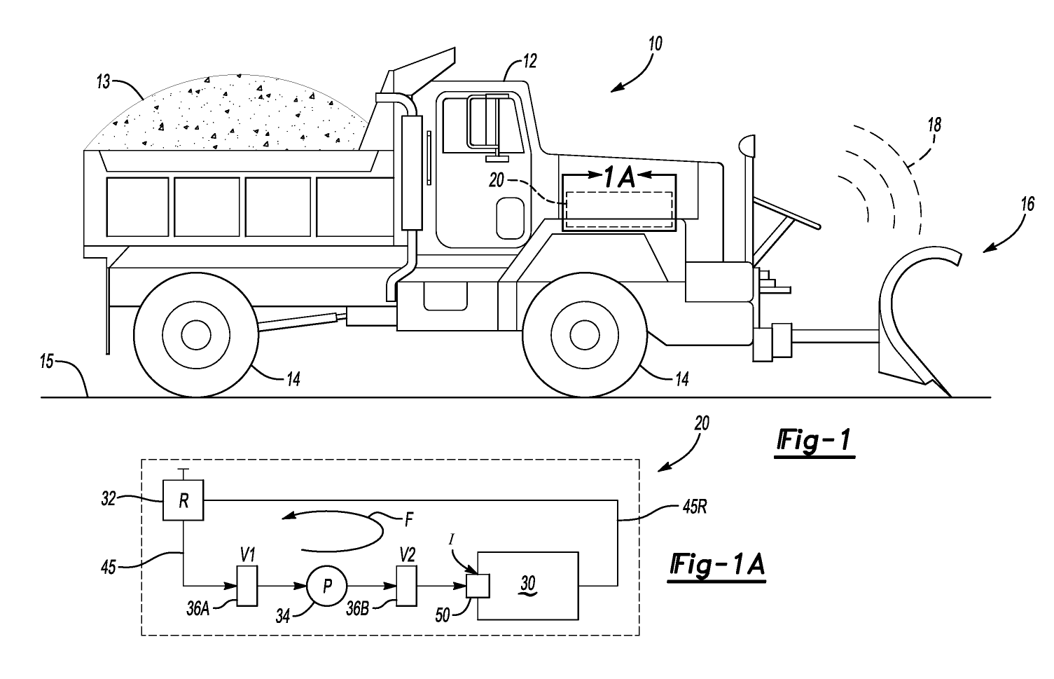

Referring to the drawings, wherein like reference numbers refer to the same or like components in the several Figures, and beginning with FIG. 1, an example vehicle 10 includes a vehicle body 12 and road wheels 14. Such a road vehicle may be embodied as a work truck as depicted, a passenger vehicle, or any other type of road vehicle. However, the present disclosure is not limited to vehicle applications. For instance, the disclosure may be applied to aircraft, boats and other marine vehicles, trains, robots, or any other mobile platform, as well as stationary systems such as power plants, residential applications, appliances, and the like, without departing from the intended inventive scope. For illustrative consistency, however, the description is tailored hereinafter to the vehicle 10 shown in FIG. 1 using an example salt truck/snowplow application without limiting applications to such an embodiment.

The vehicle body 12 may partially shield or enclose a fluid system 20 as indicated by double-headed arrow 1A, an example of which is shown in FIG. 1A, having a fluid connector 50 providing cathodic protection against corrosion as described below. The vehicle 10 may be embodied as a typical snow plow/salt truck transporting salt 13 or other potentially corrosive materials, and having a plow blade 16 affixed to the vehicle body 12. During normal operation of the vehicle 10, operation of the plow blade 16 and/or depositing of the salt 13 on a road surface 15 may expose the fluid system 20 to direct contact with an electrolyte solution 18. In the embodiment of FIG. 1 the electrolyte solution 18 is salt water, which typically forms when salt 13 deposited on the road surface 15 mixes with precipitation and/or melting snow and ice from the road surface 15. Salt water accumulated on the road surface 15 may splash onto surfaces of the fluid system 20, which in turn may cause corrosion.

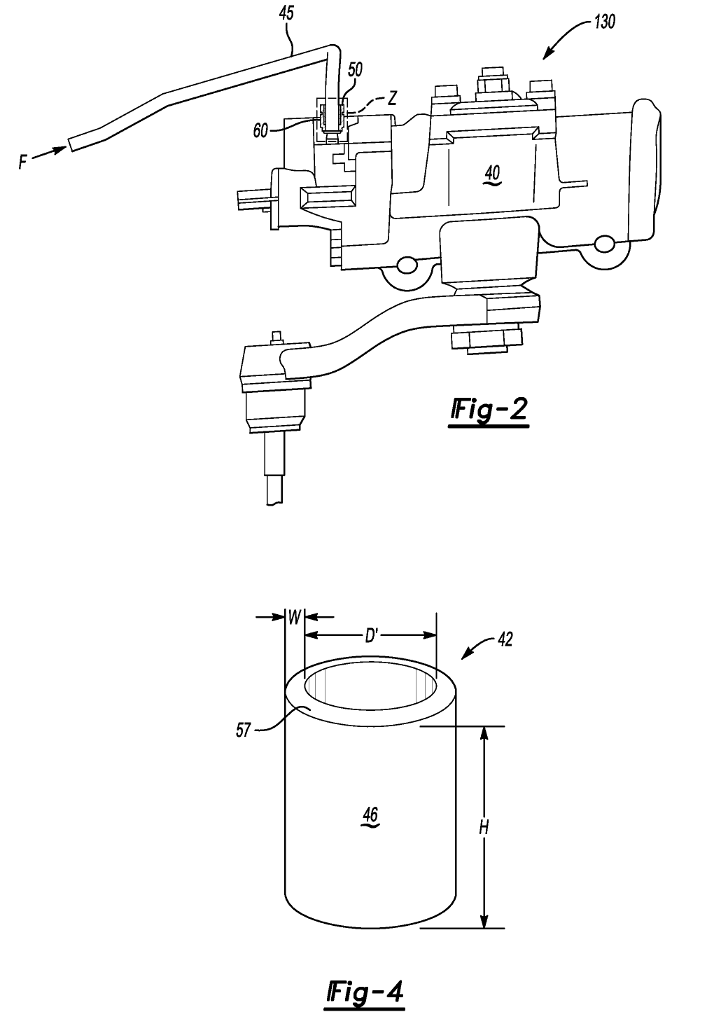

As shown in FIG. 1A, a particular area of the fluid system 20 in which avoidance of such corrosion is desirable is a conduit-to-component interface (I) between the fluid connector 50 and a component 30, e.g., a steering gear assembly 130 as shown in FIG. 2. The fluid system 20 may include a fluid reservoir (R) 32 connected to a fluid pump (P) 34 via a length of suitable fluid conduit 45, e.g., metal piping or tubing, possibly through a first valve (V1) 36A such as a flow and/or pressure-control valve. The pump 34 in turn circulates fluid (arrow F), such as oil, gasoline, hydraulic fluid, air, or water, to the component 30 via an additional length of the fluid conduit 45, possibly via a second valve (V2) 36B that is similarly or identically configured to the first valve 36A. A return line 45R exhausts expended fluid (arrow F) to the fluid reservoir 32 when the fluid (arrow F) is a liquid suitable for filtration via a filter media (not shown), and with the filtered fluid thereafter recirculated through the fluid system 20.

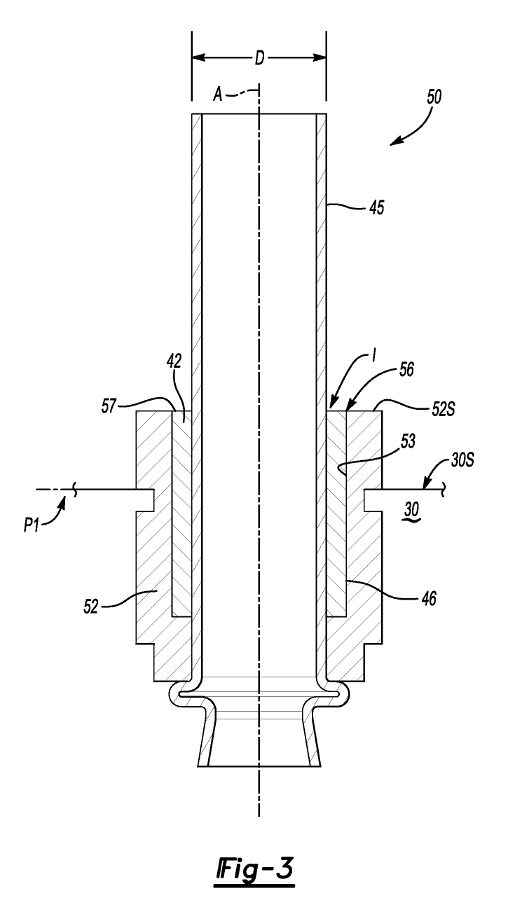

The fluid conduit 45 is connected to the component 30 via the fluid connector 50, with an example of such a connection depicted in FIGS. 2 and 3. For instance, in FIG. 2 an example component 30 in the form of a steering gear assembly 130 is connected to the pump 34 of FIG. 1 via the fluid conduit 45 in a sealing zone (Z) such that fluid (arrow F) flows into the steering gear assembly 130 through the fluid conduit 45 and the fluid connector 50. The steering gear assembly 130 may include a housing 40 that defines an opening 60 into which the fluid connector 50 is inserted and securely fastened, e.g., via a torque wrench as is known in the art.

With reference to FIG. 3, the fluid conduit 45 in proximity to the component 30 includes a longitudinal axis (A) and an outer diameter (D). The component 30 has an outer surface 30S arranged along a plane (P1), with the longitudinal axis (A) being orthogonally arranged with respect to the plane (P1), or substantially so, when installed in certain applications. A connector body 52 of the fluid connector 50 has an inner circumferential wall 53 that defines an internal recess 56. The connector body 52 ultimately receives the sacrificial anode 42 within the internal recess 56 and thereafter circumscribes the sacrificial anode 42. For instance, the sacrificial anode 42 may be press-fitted into the internal recess 56 such that retention of the sacrificial anode 42 is achieved solely by an interference fit. The fluid conduit 45 is thereafter inserted fully through the sacrificial anode 42 and into the component 30.

Referring briefly to FIG. 4, the sacrificial anode 42 may have a cylindrical outer shape, i.e., a circular cross section with an outer wall 46 of a height (H) equal to that of the internal recess 56 of the connector body 52 shown in FIG. 3. This 1:1 ratio ensures that an upper surface 57 of the sacrificial anode 42 with a width (W) is flush with an upper surface 52S of the connector body 52 when the sacrificial anode 42 is fully inserted into the internal recess 56. The sacrificial anode 42 defines a center opening having a diameter (D′) that is slightly smaller than the outer diameter (D) of the fluid conduit 45 shown in FIG. 3, e.g., in the range of 1-3 mm less than the outer diameter (D), which helps ensure the free rotation of the fluid conduit 45 about the longitudinal axis (A).

In different embodiments, the sacrificial anode 42 of FIG. 4 may be constructed substantially of a material that is configured to corrode in the presence of the particular electrolyte solution 18 of FIGS. 1 and 3. The actual materials of construction of the sacrificial anode 42 can be expected to vary with the application or use. Example materials suitable with electrolyte solution 18 in the form of salt water include aluminum, magnesium, and zinc, although those of ordinary skill in the art may conceive of different materials for the same or other applications.

Similarly, because the desired amount of time in which useful cathodic protection is ultimately provided to the connector body 52 will vary with the composition of the electrolyte solution 18, temperature, and the materials selected for construction of the sacrificial anode 42, the width (W) of the walls 46 of the sacrificial anode 42 may be determined as a function of such qualities so as to properly tune the performance of the sacrificial anode to the expected conditions of the application.

Referring again to FIG. 3, in a typical installed configuration the plane (P1) of the upper surface 30S may be substantially horizontal, e.g., within ±20 degrees of true horizontal. In this position, the electrolyte solution 18 has a tendency of accumulating on the upper surface 52S. In many applications for the fluid connector 50, particularly the example hydraulic fluid tube nut connection shown in FIGS. 2 and 3, the fluid conduit 45 is required to freely rotate about the longitudinal axis (A) within the connector body 52. As a result, infiltration can occur of the electrolyte fluid 18 past the small gap providing the needed tolerance at or along the interface (I). For example, salt water can run down the outer wall of the fluid conduit 45 due to effects of gravity and thereafter become trapped between the fluid conduit 45 and connector body 52, ultimately causing corrosion to occur.

To prevent such corrosion from occurring, or at least delay its onset, the sacrificial anode 42 may be inserted or press-fitted into the connector body 52 and exposed to the electrolyte solution 18. The sacrificial anode 42 remains wetted by the electrolyte solution 18 while the fluid system 20 remains in operation, which allows the sacrificial anode 42 and not the connector body 52 to be slowly consumed over the life of the component 30. In this manner, the sacrificial anode 42 provides cathodic protection from corrosive elements present in the surrounding operating environment. This in turn improves the robustness of the fluid system 20 and the vehicle 10 or other top-level system using such a fluid system 20 by reducing the risk of fluid leaks and permitting extended service access to the component 30 at an interface between the component and the fluid connector 50.

Functionally, the use of the sacrificial anode 42 described herein when operating in the presence of the electrolyte solution 18 effectively forms a battery having a very low voltage and current. Thus, as long as sufficient amounts of the sacrificial anode 42 remain intact, a degree of cathodic protection is afforded along the interface (I) of FIG. 3. In this manner, the sacrificial anode 42 can be consumed over a life of the component 30 in lieu of the connector body 52 so as to prevent or delay onset of corrosion of the connector body 52.

While aspects of the present disclosure have been described in detail with reference to the illustrated embodiments, those skilled in the art will recognize that changes may be made without departing from the scope of the present disclosure. That is, the present disclosure is not limited to the precise construction and compositions disclosed herein. Additionally, as used herein with respect to any disclosed values or ranges, the term “about” indicates that the stated numerical value allows for slight imprecision, e.g., reasonably close to the value or nearly, such as ±10 percent of the stated values or ranges. If the imprecision provided by the term “about” is not otherwise understood in the art with this ordinary meaning, then “about” as used herein indicates at least variations that may arise from ordinary methods of measuring and using such parameters. Disclosure of ranges includes disclosure of all values and further divided ranges within the entire range. The term “substantially” is intended to mean all or almost all, i.e., at least 50 percent of, and ideally 75 percent or more of.

While the best modes for carrying out the disclosure have been described in detail, those familiar with the art to which this disclosure relates will recognize various alternative designs and embodiments within the scope of the appended claims.

1. A fluid connector for connecting a fluid conduit to a component in the presence of an electrolyte solution, the fluid connector comprising:
a connector body including an inner circumferential wall defining a through-hole with an opening at one end thereof and an internal recess adjoining the opening; and
a sacrificial anode seated inside the internal recess, exposed from the connector body through the opening, and circumscribed by the connector body,
wherein the sacrificial anode is constructed of a material that is configured to be consumed over a life of the component to thereby prevent or delay corrosion of the connector body by the electrolyte solution.

2. The fluid connector of claim 1, wherein the sacrificial anode is press-fit into the internal recess such that the sacrificial anode is retained within the connector body by an interference fit.

3. The fluid connector of claim 1, wherein the sacrificial anode is seated inside the internal recess and exposed via the through-hole opening such that an end surface of the sacrificial anode is substantially flush with an outer surface of the connector body.

4. The fluid connector of claim 1, wherein the sacrificial anode is constructed substantially of zinc, magnesium, or aluminum, or any combination thereof.

5. The fluid connector of claim 1, wherein the sacrificial anode is cylindrical.

6. The fluid connector of claim 1, wherein the component is a steering gear assembly of a vehicle, and wherein the connector body is a tube nut configured to mount to a housing of the steering gear assembly.

7. The fluid connector of claim 1, wherein the inner circumferential wall further defines a cylindrical surface adjacent the internal recess, the cylindrical surface having a first diameter and the internal recess having a second diameter greater than the first diameter.

8. The fluid connector of claim 7, wherein an inner surface of the sacrificial anode is substantially flush with the cylindrical surface of the connector body such that the fluid conduit can be inserted into both the sacrificial anode and the connector body.

9. A fluid system for use in the presence of an electrolyte solution, the fluid system comprising:
a component with a housing;
a fluid conduit;
a pump in fluid communication with the component via the fluid conduit; and
a fluid connector connecting the fluid conduit to the component, the fluid connector including:
a connector body attached to the component housing and including an inner circumferential wall defining a through-hole with an opening at one end thereof and an internal recess adjoining the opening; and
a sacrificial anode seated inside the internal recess, exposed from the connector body via the through-hole opening, and circumscribed by the connector body, the sacrificial anode including a center opening receiving therethrough the fluid conduit,
wherein the sacrificial anode is constructed of a material that is configured to be consumed over a life of the component to thereby prevent or delay corrosion of the body by the electrolyte solution.

10. The fluid system of claim 9, wherein the sacrificial anode is press-fit into the internal recess such that the sacrificial anode is retained within the connector body by an interference fit.

11. The fluid system of claim 9, wherein the sacrificial anode is seated inside the internal recess and exposed via the through-hole opening such that an end surface of the sacrificial anode is substantially flush with an outer surface of the connector body.

12. The fluid system of claim 9, wherein the sacrificial anode is constructed substantially of zinc, magnesium, or aluminum, or any combination thereof.

13. The fluid system of claim 9, wherein the sacrificial anode is cylindrical.

14. The fluid system of claim 9, wherein the component is a steering gear assembly of a vehicle, and wherein the connector body is a tube nut mounted to the housing of the steering gear assembly.

15. The fluid system of claim 9, wherein the inner circumferential wall further defines a cylindrical surface adjacent the internal recess, the cylindrical surface having a first diameter and the internal recess having a second diameter greater than the first diameter.

16. The fluid system of claim 15, wherein an inner surface of the sacrificial anode is substantially flush with the cylindrical surface of the connector body such that the fluid conduit passes through both the sacrificial anode and the connector body and into the component.

17. A vehicle for use in the presence of salt water, the vehicle comprising:
a vehicle body; and
a fluid system connected to the vehicle body, the fluid system including:
a component with a housing;
a fluid conduit;
a pump in fluid communication with the component via the fluid conduit, and operable for circulating a fluid to the component; and
a fluid connector connecting the fluid conduit to the component, the fluid connector including:
a connector body attached to the component housing and including an inner circumferential wall defining a through-hole with an opening at one end thereof and an internal recess adjoining the opening; and
a sacrificial anode that is press-fitted into the internal recess, exposed from the connector body via the through-hole opening, circumscribed by the connector body, and constructed of a material that is configured to be consumed over a life of the component to thereby prevent or delay corrosion of the connector body due to contact with the salt water.

18. The vehicle of claim 17, wherein the component is a steering gear assembly.

19. The vehicle of claim 18, wherein the fluid circulated by the pump is hydraulic fluid for actuating the steering gear assembly, and wherein the connector body is a hydraulic fluid tube nut.

20. The vehicle of claim 19, wherein the material of the sacrificial anode includes aluminum, magnesium, or zinc.
